(19) United States
(12) Patent Application Publication
(10) Pub. No.: US 2025/0247001 A1
(43) Pub. Date: Jul. 31, 2025

(54) INDUCTOR AND DC-DC CONVERTER

(71) Applicant: TDK Corporation, Tokyo (JP)

(72) Inventors: Haruka AIBA, Tokyo (JP); Tomofumi KURODA, Tokyo (JP); Hajime KUWAJIMA, Tokyo (JP); Atsushi KOYAMA, Tokyo (JP)

(73) Assignee: TDK Corporation, Tokyo (JP)

(21) Appl. No.: 19/040,872

(22) Filed: Jan. 30, 2025

(30) Foreign Application Priority Data
Jan. 31, 2024 (JP) 2024-012988

(51) Int. Cl. H02M 3/156; H01F 17/04; H01F 27/25

(52) U.S. Cl. CPC H02M 3/156; H01F 27/25; H01F 17/04; H01F 2017/048

(57) ABSTRACT

An inductor includes a coil conductor, a magnetic body, and a resin material including the coil conductor and the magnetic body therein, and a gap is provided between the resin material and at least one first surface of the magnetic body.

### CROSS-REFERENCE TO RELATED APPLICATION

This application is based upon and claims the benefit of priority from Japanese Patent Application No. 2024-012988, filed on Jan. 31, 2024, the entire contents of which are incorporated herein by reference.

### TECHNICAL FIELD

The present disclosure relates to an inductor and a DC-DC converter.

### BACKGROUND

Conventionally, there is an inductor disclosed in International Publication No. 2018-079402. The inductor includes a coil conductor and a magnetic body serving as a core. In addition, the inductor has a resin material including a coil conductor and a magnetic body therein.

### SUMMARY

An inductor according to one aspect of the present disclosure includes a coil conductor, a magnetic body, and a resin material including the coil conductor and the magnetic body therein, in which a gap is provided between the resin material and at least one first surface of the magnetic body.

A DC-DC converter according to one aspect of the present disclosure includes the inductor described above.

### BRIEF DESCRIPTION OF THE DRAWINGS

FIG. 1 is a perspective view of an inductor according to the present embodiment;

FIG. 2 is a development view of an inductor;

FIG. 3 is a diagram illustrating a circuit of a DC-DC converter using the inductor illustrated in FIG. 1;

FIG. 4 is a cross-sectional view taken along line IV-IV of FIG. 1;

FIG. 5A is an enlarged view of FIG. 4, and FIG. 5B is a cross-sectional view taken along line Vb-Vb illustrated in FIG. 4;

FIG. 6 is a cross-sectional view illustrating an inductor according to a modification example;

FIG. 7 is a diagram illustrating a circuit of a DC-DC converter according to a modification example;

FIGS. 8A and 8B are diagrams illustrating an inductor according to a modification example;

FIGS. 9A to 9D are diagrams illustrating an inductor according to a modification example; and

FIGS. 10A to 10D are diagrams illustrating an inductor according to a modification example.

### DETAILED DESCRIPTION

Here, the temperature of the inductor increases during use. In this case, the magnetic body may thermally expand inside the resin material. In a case where a thermal expansion coefficient of the magnetic body is larger than a thermal expansion coefficient of the resin material, structural defects such as cracks may occur in the resin material due to pressing of the thermally expanded magnetic body.

Therefore, an object of the present disclosure is to provide an inductor and a DC-DC converter capable of suppressing structural defects due to thermal expansion of a magnetic body.

According to one aspect of the present disclosure, it is possible to provide an inductor and a DC-DC converter capable of suppressing structural defects due to thermal expansion of a magnetic body.

Hereinafter, some embodiments of the present disclosure will be described in detail. In this regard, the present disclosure is not limited to the following embodiments.

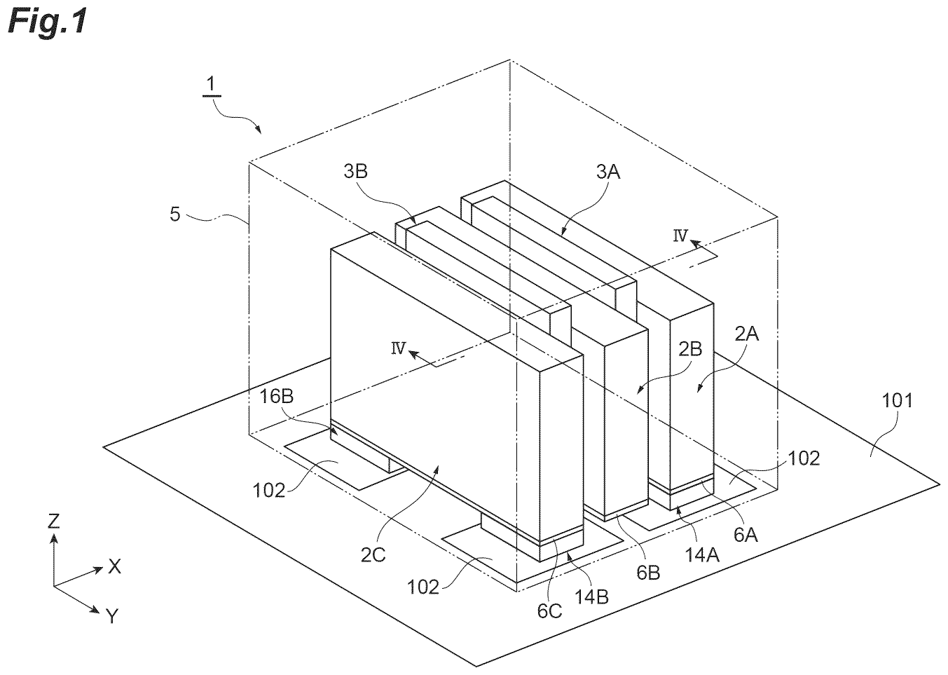

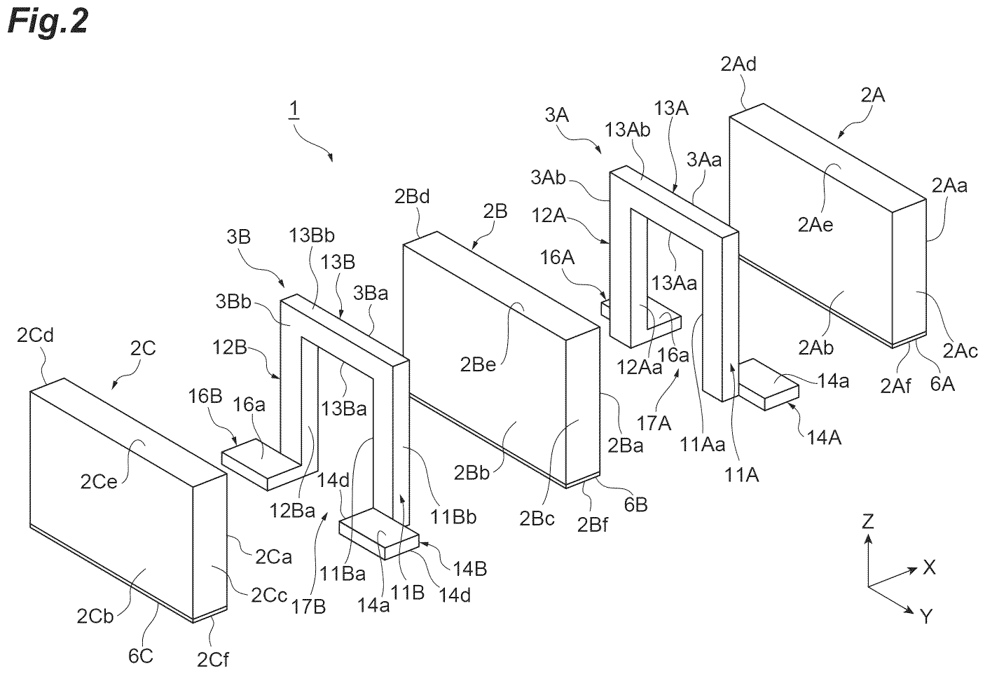

First, a schematic configuration of an inductor 1 according to the present embodiment will be described with reference to FIGS. 1 and 2. FIG. 1 is a perspective view of an inductor 1 according to the present embodiment. FIG. 2 is a development view of the inductor 1. FIG. 1 illustrates a state in which the inductor 1 is mounted on a substrate 101. The inductor 1 according to the present embodiment is formed by stacking the magnetic bodies 2A, 2B, and 2C serving as cores and the coil conductors 3A and 3B in the X-axis direction. In the present embodiment, the X-axis direction, a Y-axis direction, and a Z-axis direction are orthogonal to each other. In the present embodiment, the X-axis direction corresponds to a “first direction” in the claims, and the Y-axis direction orthogonal to the X-axis direction corresponds to a “second direction” in the claims.

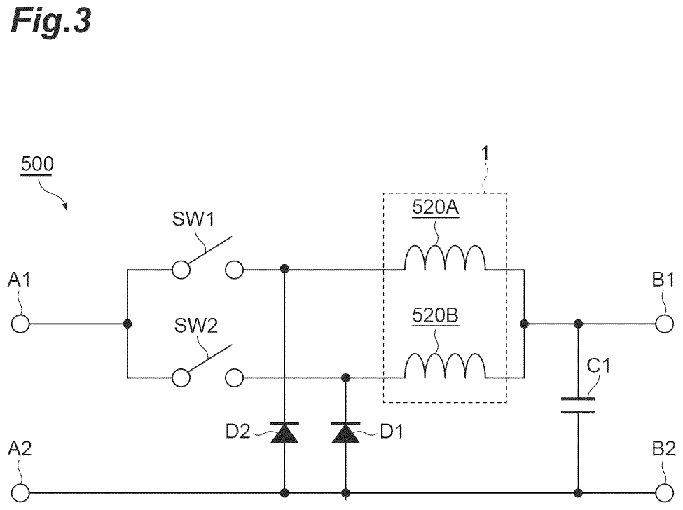

As illustrated in FIG. 1, the inductor 1 includes a magnetic body 2A, a magnetic body 2B, a magnetic body 2C, a coil conductor 3A, a coil conductor 3B, a resin material 5, a resin member 6A, a resin member 6B, and a resin member 6C. In FIG. 1, the resin material 5 is indicated by a virtual line in order to facilitate understanding of the features. The inductor 1 may be adopted as a choke coil of a circuit of the DC-DC converter 100 illustrated in FIG. 3.

The magnetic body 2A and the magnetic body 2B are disposed to face each other while being separated from each other in the X-axis direction. The magnetic body 2B and the magnetic body 2C are disposed to face each other while being separated from each other in the X-axis direction. The magnetic bodies 2A, 2B, and 2C are arranged in order from the positive side in the X-axis direction. The magnetic bodies 2A, 2B, and 2C have rectangular parallelepiped shapes. The magnetic bodies 2A, 2B, and 2C have the same shape. Note that the magnetic bodies 2A, 2B, and 2C may have a shape other than a rectangular parallelepiped. The magnetic bodies 2A, 2B, and 2C may be made of, for example, a magnetic material such as a sintered magnetic core such as MnZn-based ferrite or NiZn-based ferrite or a multilayer magnetic core formed by laminating soft magnetic metal plates. The magnetic permeability of the magnetic bodies 2A, 2B, and 2C may be 1000 or more. The magnetic bodies 2A, 2B, and 2C may have substantially the same or different magnetic characteristics.

The pair of coil conductors 3 (3A and 3B) included in the inductor 1 may be adopted for each choke coil of a circuit of a DC-DC converter 500 illustrated in FIG. 3. The DC-DC converter 500 is a multiphase converter including a pair of conversion portions including switching elements SW1 and SW2, choke coils 520A and 520B, and diodes D1 and D2, and these conversion portions are connected in parallel, and the inductor 1 may be adopted as the choke coils 520A and 520B of each conversion portion. Describing the configuration of the DC-DC converter 500 in more detail, the DC-DC converter 500 includes a pair of input terminals A1 and A2, a pair of output terminals B1 and B2, the switching element SW1 and the choke coil 520A connected in this order in series between the input terminal A1 and the output terminal B1, the switching element SW2 and the choke coil 520B connected in this order in series between the input terminal A1 and the output terminal B1, and a capacitor C1 connected between the output terminals B1 and B2. The circuit including the switching element SW1 and the choke coil 520A and the circuit including the switching element SW2 and the choke coil 520B are connected in parallel between the input terminal A1 and the output terminal B1. The input terminal A2 and the output terminal B2 configure a ground line. The diode D2 is connected in the reverse direction between a connection point of the switching element SW1 and the choke coil 520A and the ground line, and the diode D1 is connected in the reverse direction between a connection point of the switching element SW2 and the choke coil 520B and the ground line. The switching elements SW1 and SW2 are alternately turned on and off by a control circuit (not illustrated), and thus an output voltage obtained by stepping down an input voltage is generated. By configuring the pair of choke coils 520A and 520B in the DC-DC converter 500 with the pair of coil conductors 3A and 3B of the inductor 1, the number of components configuring the DC-DC converter 500 can be reduced.

As illustrated in FIG. 2, the magnetic body 2A has principal surfaces 2Aa and 2Ab, end surfaces 2Ac and 2Ad, and side surfaces 2Ae and 2Af. The principal surfaces 2Aa and 2Ab are surfaces opposed to each other in the X-axis direction. The principal surface 2Aa is disposed on the positive side in the X-axis direction, and the principal surface 2Ab is disposed on the negative side in the X-axis direction. The end surfaces 2Ac and 2Ad are surfaces opposed to each other in the Y-axis direction. The end surface 2Ac is disposed on the positive side in the Y-axis direction, and the end surface 2Ad is disposed on the negative side in the Y-axis direction. The side surfaces 2Ae and 2Af are surfaces opposed to each other in the Z-axis direction. The side surface 2Ae is disposed on the positive side in the Z-axis direction, and the side surface 2Af is disposed on the negative side in the Z-axis direction.

The magnetic body 2B has principal surfaces 2Ba and 2Bb, end surfaces 2Bc and 2Bd, and side surfaces 2Be and 2Bf. The magnetic body 2C has principal surfaces 2Ca and 2Cb, end surfaces 2Cc and 2Cd, and side surfaces 2Ce and 2Cf. These surfaces have configurations similar to the principal surfaces 2Aa and 2Ab, the end surfaces 2Ac and 2Ad, and the side surfaces 2Ae and 2Af of the magnetic body 2A.

The principal surface 2Ab of the magnetic body 2A and the principal surface 2Ba of the magnetic body 2B are disposed to face each other in a state of being separated from each other in the X-axis direction. The principal surface 2Bb of the magnetic body 2B and the principal surface 2Ca of the magnetic body 2C are disposed to face each other in a state of being separated from each other in the X-axis direction. As a result, the magnetic body 2A is disposed to sandwich a portion (region 17A) located between conductor portions 11A and 12A that will be described later with the magnetic body 2B in the X-axis direction. The magnetic body 2C is disposed to sandwich a portion (region 17B) located between conductor portions 11B and 12B described later with the magnetic body 2B in the X-axis direction. In the present embodiment, the end surfaces 2Ac and 2Ad, the end surfaces 2Bc and 2Bd, and the end surfaces 2Cc and 2Cd are disposed at the same position in the Y-Z plane to overlap each other when viewed from the X-axis direction. Therefore, the magnetic bodies 2A, 2B, and 2C may have the same area as viewed from the X-axis direction. In addition, the thicknesses of the magnetic bodies 2A, 2B, and 2C in the X-axis direction may be the same. That is, the magnetic bodies 2A, 2B, and 2C may have the same size. Note that, in the present specification, “same position” includes a positional deviation within a range caused by a manufacturing error or the like, and “same” and “same size” include an error within a range caused by a manufacturing variation.

The coil conductor 3A includes a conductor portion 11A, a conductor portion 12A, a coupling portion 13A, a terminal portion 14A, and a terminal portion 16A. The material of the coil conductor 3A includes a metal selected from, for example, Cu, Ag, Au, Al, Ni, and Sn.

The conductor portions 11A and 12A extend in the Z-axis direction and are disposed between the magnetic body 2A and the magnetic body 2B in the X-axis direction. The conductor portion 11A is disposed on the positive side in the Y-axis direction, and the conductor portion 12A is disposed on the negative side in the Y-axis direction. The coupling portion 13A is a member that couples the conductor portion 11A and the conductor portion 12A. The coupling portion 13A is connected to the end portions of the conductor portions 11A and 12A on the positive side in the Z-axis direction and extends in the Y-axis direction. The terminal portion 14A is provided at the end portion of the conductor portion 11A on the negative side in the Z-axis direction, and extends to the positive side in the X-axis direction and the positive side in the Y-axis direction. The terminal portion 14A is configured by forming a part of the vicinity of the end portion of the conductor portion 11A on the negative side in the Z-axis direction to be wide toward the positive side in the Y direction and bending the wide portion toward the positive side in the X direction. The terminal portion 16A is provided at the end portion of the conductor portion 12A on the negative side in the Z-axis direction, and extends to the positive side in the X-axis direction and the negative side in the Y-axis direction. The terminal portion 16A is configured by forming a part of the vicinity of the end portion of the conductor portion 12A on the negative side in the Z-axis direction to be wide toward the negative side in the Y direction and bending the wide portion toward the positive side in the X direction. The terminal portions 14A and 16A are bonded to the electrodes 102 (see FIG. 1) of the substrate 101. As a result, the inductor 1 is mounted on the substrate 101. The conductor portions 11A and 12A need not be parallel to the Z-axis direction as long as the conductor portions 11A and 12A extend in the Z-axis direction. The coupling portion 13A need not be parallel to the Y-axis direction as long as the coupling portion 13A extends in the Y-axis direction.

The coil conductor 3A has a side surface 3Aa on the positive side in the X-axis direction and a side surface 3Ab on the negative side in the X-axis direction. The side surface 3Aa is formed by disposing the side surfaces of the conductor portions 11A and 12A and the coupling portion 13A on the positive side in the X-axis direction on the same plane. The terminal portions 14A and 16A protrude further toward the positive side in the X-axis direction than the side surface 3Aa. The side surface 3Aa faces the principal surface 2Ab of the magnetic body 2A in the X-axis direction and is in contact with the principal surface 2Ab. The side surface 3Ab is formed by arranging the conductor portions 11A and 12A and the side surface on the negative side in the X-axis direction of the coupling portion 13A on the same surface. The side surface 3Ab faces the principal surface 2Ba of the magnetic body 2B in the X-axis direction and is in contact with the principal surface 2Ba. Since the magnetic bodies 2A, 2B, and 2C and the coil conductors 3A and 3B are disposed in contact with each other, a positional relationship among the magnetic bodies 2A, 2B, and 2C particularly in the X-axis direction is stabilized, so that a variation in inductance can be reduced. In the present specification, “contact” includes not only a case where the magnetic bodies 2A and 2B are in direct contact with the coil conductor 3A but also a case where the magnetic bodies 2A and 2B are in indirect contact with the coil conductor 3A via an insulating layer, an adhesive layer, or the like. The same applies to contact between the magnetic bodies 2B and 2C that will be described later and the coil conductor 3B.

As illustrated in FIG. 2, the coil conductor 3B includes a conductor portion 11B, a conductor portion 12B, a coupling portion 13B, a terminal portion 14B, and a terminal portion 16B. A material of the coil conductor 3B may be similar to that of the coil conductor 3A.

The conductor portions 11B and 12B extend in the Z-axis direction and are disposed between the magnetic body 2B and the magnetic body 2C in the X-axis direction. The conductor portion 11B is disposed on the positive side in the Y-axis direction, and the conductor portion 12B is disposed on the negative side in the Y-axis direction. The coupling portion 13B is a member that couples the conductor portion 11B and the conductor portion 12B. The coupling portion 13B is connected to the end portions of the conductor portions 11B and 12B on the positive side in the Z-axis direction and extends in the Y-axis direction. The terminal portion 14B is provided at the end portion of the conductor portion 11B on the negative side in the Z-axis direction, and extends to the negative side in the X-axis direction and the positive side in the Y-axis direction. The terminal portion 14B is configured by forming a part in the vicinity of the negative end portion of the conductor portion 11B in the Z-axis direction to be wide toward the positive side in the Y-axis direction and bending the wide portion toward the negative side in the X-axis direction. The terminal portion 16B is provided at the end portion of the conductor portion 12B on the negative side in the Z-axis direction, and extends to the negative side in the X-axis direction and the negative side in the Y-axis direction. The terminal portion 16B is configured by forming a part in the vicinity of the end portion of the conductor portion 12B on the negative side in the Z-axis direction to be wide toward the negative side in the Y-axis direction and bending the wide portion toward the negative side in the X-axis direction. The terminal portions 14B and 16B are bonded to the electrodes 102 (see FIG. 1) of the substrate 101. As a result, the inductor 1 is mounted on the substrate 101. Note that the conductor portions 11B and 12B need not be parallel to the Z-axis direction as long as the conductor portions 11B and 12B extend in the Z-axis direction. The coupling portion 13B need not be parallel to the Y-axis direction as long as the coupling portion 13B extends in the Y-axis direction.

The coil conductor 3B has a side surface 3Ba on the positive side in the X-axis direction and a side surface 3Bb on the negative side in the X-axis direction. The side surface 3Ba is formed by disposing the side surfaces of the conductor portions 11B and 12B and the coupling portion 13B on the positive side in the X-axis direction on the same plane. The side surface 3Ba faces the principal surface 2Bb of the magnetic body 2B in the X-axis direction and is in contact with the principal surface 2Bb. The side surface 3Bb is formed by disposing the side surfaces of the conductor portions 11B and 12B and the coupling portion 13B on the negative side in the X-axis direction on the same plane. The terminal portions 14B and 16B protrude further toward the negative side in the X-axis direction than the side surface 3Bb. The side surface 3Bb faces the principal surface 2Ca of the magnetic body 2C in the X-axis direction and is in contact with the principal surface 2Ca.

The coil conductor 3A and the coil conductor 3B have a plane-symmetrical structure with respect to the ZY plane. Therefore, when viewed from the X-axis direction, the coil conductor 3A and the coil conductor 3B are formed in the same shape to overlap each other. Note that “plane symmetry” includes a positional deviation within a range caused by a manufacturing error or the like, and the “same shape” includes an error within a range caused by a manufacturing variation.

The resin member 6A is disposed to cover the side surface 2Af of the magnetic body 2A on the negative side in the Z-axis direction. The resin member 6B is disposed to cover the side surface 2Bf of the magnetic body 2B on the negative side in the Z-axis direction. The resin member 6C is disposed to cover the side surface 2Cf of the magnetic body 2C on the negative side in the Z-axis direction. The resin members 6A, 6B, and 6C are sheet-like members that cover substantially the entire surfaces of the side surfaces 2Af, 2Bf, and 2Cf. A material of the resin members 6A, 6B, and 6C is not particularly limited, and polyimide, polyamideimide, fluororesin, or the like may be adopted. As the resin members 6A, 6B, and 6C, for example, Kapton (registered trademark) tape may be adopted.

The side surfaces 2Af and 2Cf (surfaces on the other side) of the magnetic bodies 2A and 2C on the negative side in the Z-axis direction are placed on upper surfaces 14a and 16a of the terminal portions 14A, 16A, 14B, and 16B via the resin members 6A and 6C. As a result, the resin member 6A is disposed between the magnetic body 2A and the terminal portions 14A and 16A. The resin member 6C is disposed between the magnetic body 2C and the terminal portions 14B and 16B. In the present embodiment, the side surface 2Bf of the magnetic body 2B on the negative side in the Z-axis direction is disposed at the same height as the side surfaces 2Af and 2Cf of the other magnetic bodies 2A and 2C on the negative side in the Z-axis direction. Note that the “same height” includes an error within a range caused by a manufacturing variation.

Next, the resin material 5 will be described. The resin material 5 covers the assembly of the magnetic bodies 2A, 2B, and 2C and the coil conductors 3A and 3B. As described above, the resin material 5 includes the coil conductors 3A and 3B and the magnetic bodies 2A, 2B, and 2C therein. The resin material 5 exposes at least the lower surfaces of the terminal portions 14A, 16A, 14B, and 16B. Therefore, the resin material 5 covers at least the side surfaces 2Ae, 2Be, and 2Ce of the magnetic bodies 2A, 2B, and 2C on the positive side in the Z-axis direction. The resin material 5 may contain a magnetic powder. Specifically, a thermosetting resin such as epoxy is adopted as a material of the resin material 5. In a case where the resin material 5 contains a magnetic powder, a mixture of a soft magnetic metal powder and a resin or the like may be adopted. As the soft magnetic metal powder, an iron-silicon alloy, permalloy, sendust, amorphous, nanocrystalline alloy, or a mixture thereof may be used. In a case where the resin material 5 contains a magnetic powder, the magnetic permeability of the resin material 5 may be 5 or more, or 20 or more. The magnetic permeability of the resin material 5 may be 100 or less, and may be 50 or less. The resin material 5 may have a magnetic permeability lower than that of the magnetic bodies 2A, 2B, and 2C. The resin material 5 is disposed in the regions 17A and 17B. That is, the resin material 5 is formed to cover the inner portions 11Aa, 11Ba, 12Aa, 12Ba, 13Aa, and 13Ba.

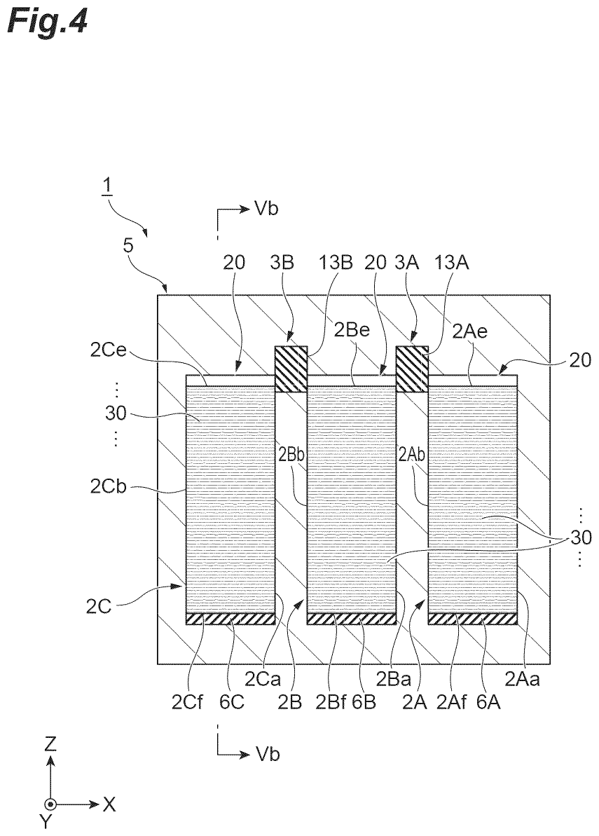

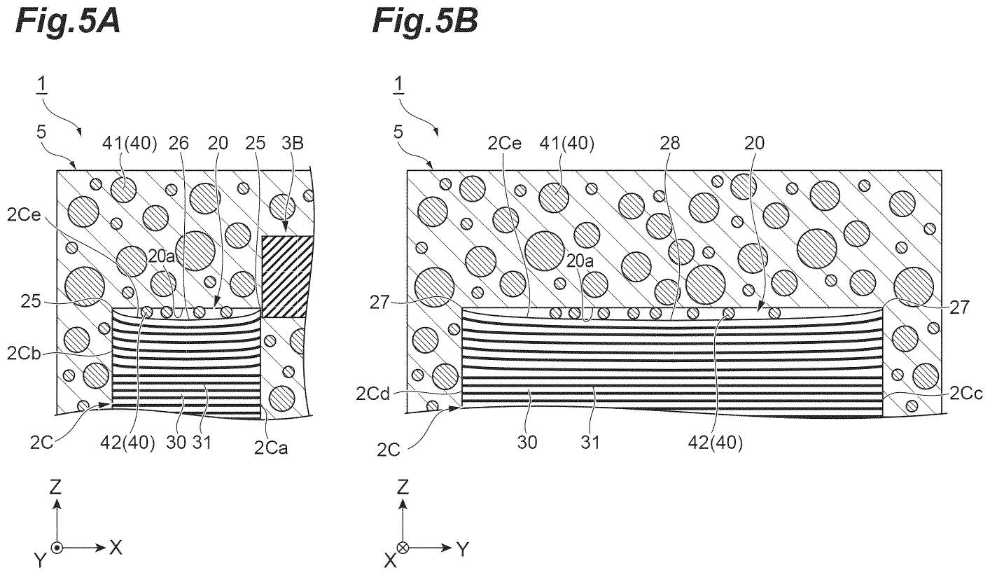

Next, a cross-sectional shape of the inductor 1 will be described with reference to FIG. 4. FIG. 4 is a cross-sectional view taken along line IV-IV illustrated in FIG. 1. As illustrated in FIG. 4, the inductor 1 has a gap 20 between the resin material 5 and at least one of the side surfaces 2Ae, 2Be, and 2Ce (first surfaces) of the magnetic bodies 2A, 2B, and 2C. The magnetic bodies 2A, 2B, and 2C have a stacked structure of a magnetic ribbon 30 and an adhesive resin 31 (see FIGS. 5A and 5B). A stacking direction of the stacked structure is the Z-axis direction. The side surfaces 2Ae, 2Be, and 2Ce on which the gap 20 is formed are outermost surfaces in the stacking direction (Z-axis direction) in the stacked structure. The side surfaces 2Ae, 2Be, and 2Ce are surfaces intersecting the stacking direction. The side surfaces 2Ae, 2Be, and 2Ce are substantially orthogonal to the stacking direction. Substantially orthogonal indicates a state in which the side surfaces 2Ae, 2Be, and 2Ce are allowed to be curved as will be described later.

The magnetic bodies 2A, 2B, and 2C have side surfaces 2Af, 2Bf, and 2Cf (second surfaces) that are outermost surfaces on the opposite side to the side surfaces 2Ae, 2Be, and 2Ce in the stacking direction (Z-axis direction). The side surfaces 2Af, 2Bf, and 2Cf are surfaces intersecting the stacking direction (Z-axis direction) in the stacked structure. The side surfaces 2Af, 2Bf, and 2Cf are substantially orthogonal to the stacking direction. The resin members 6A, 6B, and 6C described above are disposed at positions facing the side surfaces 2Af, 2Bf, and 2Cf. The resin members 6A, 6B, and 6C are interposed between the resin material 5 and the side surfaces 2Af, 2Bf, and 2Cf. The resin members 6A, 6B, and 6C are in contact with the side surfaces 2Af, 2Bf, and 2Cf without a gap. The resin members 6A, 6B, and 6C may be omitted. In this case, the inductor 1 may have a gap 20 between the resin material 5 and the side surfaces 2Af, 2Bf, and 2Cf.

The resin material 5 is in close contact with four surfaces of the magnetic bodies 2A, 2B, and 2C other than the side surfaces 2Ae, 2Be, and 2Ce and the side surfaces 2Af, 2Bf, and 2Cf. The resin material 5 is in close contact with four surfaces extending in the stacking direction (Z-axis direction). Specifically, the resin material 5 is in close contact with the principal surfaces 2Aa, 2Ba, and 2Ca, the principal surfaces 2Ab, 2Bb, and 2Cb, the end surfaces 2Ac, 2Bc, and 2Cc, and the end surfaces 2Ad, 2Bd, and 3Cd. The close contact indicates a state in which the resin material 5 is in contact with a target surface without a gap. However, the resin material 5 need not be in contact with the entire surface that is a target surface, and may be separated from a part of the target surface (for example, a region that is half or less of the entire area) within a range of a manufacturing error or the like. Since parts of the principal surface 2Ab of the magnetic body 2A and the principal surface 2Ba of the magnetic body 2B are in contact with the coil conductor 3A, and parts of the principal surface 2Bb of the magnetic body 2B and the principal surface 2Ca of the magnetic body 2C are in contact with the coil conductor 3B, the principal surfaces 2Ab, 2Ba, 2Bb, and 2Ca other than the contact portions with the coil conductors 3A and 3B are in close contact with the resin material 5.

Next, the configuration of the gap 20 will be described in more detail with reference to FIGS. 5A and 5B. FIG. 5A is an enlarged cross-sectional view illustrating a configuration around the gap 20 of the magnetic body 2C illustrated in FIG. 4. FIG. 5B is a cross-sectional view taken along line Vb-Vb illustrated in FIG. 4. Note that, although the magnetic body 2C is illustrated in FIGS. 5A and 5B, the same configuration is also established for the magnetic bodies 2A and 2B. As illustrated in FIG. 5A, the magnetic ribbon 30 and the adhesive resin 31 are alternately stacked in the Z-axis direction. The magnetic ribbon 30 is a ribbon member made of a material exemplified as the material of the magnetic body 2C described above. A thickness of the magnetic ribbon 30 is not particularly limited, and may be set to 5 μm to 70 μm. The adhesive resin 31 is a material that is interposed between the pair of magnetic ribbons 30 to bond them together. As the adhesive resin 31, a material such as an epoxy resin, a polyimide resin, a polyimide amide resin, or a silicone resin may be adopted. A thickness of the adhesive resin 31 is not particularly limited, and may be set to 2 μm to 15 μm.

The above-described gap 20 is formed between the side surface 2Ce and a facing surface 20a of the resin material 5. The facing surface 20a is a surface that is separated from the side surface 2Ce toward the positive side in the Z-axis direction and faces the side surface 2Ce in the Z-axis direction. The facing surface 20a is a surface that spreads to be substantially orthogonal to the stacking direction (Z-axis direction).

The magnetic body 2C has an X-axis direction (first direction) extending along the side surface 2Ce as a lateral direction, and a Y-axis direction (second direction) extending along the side surface 2Ce and orthogonal to the X-axis direction as a longitudinal direction. Therefore, a first length dimension of the magnetic body 2C in the X-axis direction is smaller than a second length dimension of the magnetic body 2C in the Y-axis direction. The first length dimension is defined depending on a dimension between the principal surface 2Ca and the principal surface 2Cb (see FIG. 5A). The second length dimension is defined depending on a dimension between the end surface 2Cc and the end surface 2Cd (see FIG. 5B). The second length dimension is not particularly limited, and may be set to, for example, 2 mm to 10 mm. The first length dimension is not particularly limited, and may be set to, for example, 10% to 50% of the second length dimension. Note that a third length dimension of the magnetic body 2C in the Z-axis direction is not particularly limited, and may be set to, for example, 1 mm to 10 mm.

As illustrated in FIG. 5A, the gap 20 has a larger separation distance at the center than an end portion 25 of the side surface 2Ce of the magnetic body 2C in the X-axis direction. The gap 20 has a larger separation distance from the end portion 25 of the side surface 2Ce of the magnetic body 2C toward the center in the X-axis direction. The gap 20 may have a constant separation distance near the center of the side surface 2Ce of the magnetic body 2C in the X-axis direction. In addition, the resin material 5 is in contact with the magnetic body 2C in a portion of the side surface 2Ce of the magnetic body 2C near the end portion 25. In the present embodiment, the side surface 2Ce is a gently curved surface to be recessed toward the negative side in the Z-axis direction at a central position 26 in the X-axis direction. The side surface 2Ce is in contact with the facing surface 20a of the resin material 5 at the position of the end portion 25 (and the position around the end portion 25) in the X-axis direction. A separation distance between the facing surface 20a and the side surface 2Ce increases from the end portion 25 toward the central position 26. In the example illustrated in the drawing, the end portions 25 on both sides in the X-axis direction are in contact with the facing surface 20a, but one of the end portions 25 may be in contact with the facing surface 20a. In addition, both end portions 25 need not be in contact with the facing surface 20a. The end portion 25 extends in the Y-axis direction. In a case where the end portion 25 is in contact with the facing surface 20a, the entire region of the end portion 25 in the Y-axis direction may be in contact with the facing surface 20a, or a partial region may be in contact with the facing surface 20a.

As illustrated in FIG. 5B, the gap 20 has a larger separation distance at the center than an end portion 27 of the side surface 2Ce of the magnetic body 2C in the Y-axis direction. The gap 20 has a larger separation distance from the end portion 27 of the side surface 2Ce of the magnetic body 2C toward the center in the Y-axis direction. The gap 20 may have a constant separation distance near the center of the side surface 2Ce of the magnetic body 2C in the Y-axis direction. In addition, the resin material 5 is in contact with the magnetic body 2C in a portion of the side surface 2Ce of the magnetic body 2C near the end portion 27. In the present embodiment, the side surface 2Ce is a gently curved surface to be recessed toward the negative side in the Z-axis direction at a central position 28 in the Y-axis direction. The side surface 2Ce is in contact with the facing surface 20a of the resin material 5 at the position of the end portion 27 (and the position around the end portion 27) in the Y-axis direction. A separation distance between the facing surface 20a and the side surface 2Ce increases from the end portion 27 toward the central position 28. In the example illustrated in the drawing, the end portions 27 on both sides in the Y-axis direction are in contact with the facing surface 20a, but one of the end portions 27 may be in contact with the facing surface 20a. In addition, both end portions 27 need not be in contact with the facing surface 20a. The end portion 27 extends in the X-axis direction. In a case where the end portion 27 is in contact with the facing surface 20a, the entire region of the end portion 27 in the X-axis direction may be in contact with the facing surface 20a, or a partial region may be in contact with the facing surface 20a.

A magnitude of a separation distance of the gap 20 will be described. Here, a separation distance of the central positions 26 and 28 will be described. The separation distance may be set to 0.3% to 3% of the third length dimension of the magnetic body 2C in the Z-axis direction. Alternatively, the separation distance may be set to 10% to 200% of the thickness of the magnetic ribbon 30. In addition, the separation distance may be set to 10% to 200% of an average particle diameter of a second magnetic powder 42 that will be described later.

Note that the separation distance is not particularly limited as long as the gap 20 has a size capable of suppressing the occurrence of a structural defect between the magnetic body 2C and the resin material 5 due to thermal expansion of the magnetic body 2C. A thermal expansion coefficient of the magnetic body 2C in the stacking direction (Z-axis direction) is larger than a thermal expansion coefficient in the directions (the X-axis direction and the Y-axis direction) orthogonal to the stacking direction, and is larger than a thermal expansion coefficient of the resin material 5 in the Z-axis direction. For example, the thermal expansion coefficient in the directions (the X-axis direction and the Y-axis direction) orthogonal to the stacking direction may be 5% to 15% of the thermal expansion coefficient of the magnetic body 2C in the stacking direction. The thermal expansion coefficient of the resin material 5 in the Z-axis direction may be 30% to 80% of the thermal expansion coefficient of the magnetic body 2C in the stacking direction.

As illustrated in FIGS. 5A and 5B, the inductor 1 further includes a plurality of magnetic powders 40. A material of the magnetic powder 40 is not particularly limited, and pure iron, an Fe—Si alloy, permalloy, sendust, amorphous, nanocrystalline soft magnetic material, or the like may be adopted. The plurality of magnetic powders 40 include a first magnetic powder 41 present in the resin material 5 and a second magnetic powder 42 present in the gap 20. An average particle diameter of the first magnetic powder 41 may be set to 5 μm to 50 μm. An average particle diameter of the second magnetic powder 42 may be set to 5 μm to 50 μm. In the second magnetic powder 42, all grains may be stored in the gap 20, or some of the grains may be present in the gap 20. Note that a shape of the magnetic powder 40 in the drawings is spherical, but a shape is not particularly limited.

Next, functions and effects of the inductor 1 and the DC-DC converter 100 according to the present embodiment will be described. The inductor 1 according to the present embodiment includes the coil conductors 3A and 3B, the magnetic bodies 2A, 2B, and 2C, and the resin material 5 including the coil conductors 3A and 3B and the magnetic bodies 2A, 2B, and 2C therein. The inductor 1 has the gap 20 between the resin material 5 and at least one of the side surfaces 2Ae, 2Be, and 2Ce (first surfaces) of the magnetic bodies 2A, 2B, and 2C.

The resin material 5 includes the coil conductors 3A and 3B and the magnetic bodies 2A, 2B, and 2C therein. Therefore, when a current flows through the coil conductors 3A and 3B and thus the temperature of the inductor 1 increases, the magnetic bodies 2A, 2B, and 2C thermally expand in the resin material 5. On the other hand, the inductor 1 has the gap 20 between the resin material 5 and at least one of the side surfaces 2Ae, 2Be, and 2Ce (first surfaces) of the magnetic bodies 2A, 2B, and 2C. The amount of displacement due to thermal expansion of the magnetic bodies 2A, 2B, and 2C is absorbed by the gap 20. Therefore, it is possible to suppress the resin material 5 from being pressed against the thermally expanded magnetic bodies 2A, 2B, and 2C. As described above, structural defects due to thermal expansion of the magnetic bodies 2A, 2B, and 2C can be suppressed.

The magnetic bodies 2A, 2B, and 2C may have a stacked structure of the magnetic ribbon 30 and the adhesive resin 31, and the side surfaces 2Ae, 2Be, and 2Ce of the magnetic bodies 2A, 2B, and 2C may be the outermost surfaces in the stacking direction (Z-axis direction) in the stacked structure. The amount of displacement due to thermal expansion of the magnetic bodies 2A, 2B, and 2C increases in the stacking direction. Therefore, by providing the gap 20 for the side surfaces 2Ae, 2Be, and 2Ce having a large amount of displacement, structural defects due to thermal expansion can be suppressed.

The inductor 1 may further include the resin members 6A, 6B, and 6C, the magnetic bodies 2A, 2B, and 2C may have the side surfaces 2Af, 2Bf, and 2Cf (second surfaces) that are outermost surfaces on the opposite side to the side surfaces 2Ae, 2Be, and 2Ce in the stacking direction, and the resin members 6A, 6B, and 6C may be disposed at positions facing the side surfaces 2Af, 2Bf, and 2Cf. By disposing the resin members 6A, 6B, and 6C for the other side surfaces 2Af, 2Bf, and 2Cf having a large amount of displacement due to thermal expansion, displacement of the side surfaces 2Af, 2Bf, and 2Cf can be suppressed by the resin members 6A, 6B, and 6C.

The magnetic bodies 2A, 2B, and 2C may have side surfaces 2Af, 2Bf, and 2Cf that are outermost surfaces on the opposite side to the side surfaces 2Ae, 2Be, and 2Ce in the stacking direction, and the resin material 5 may be in close contact with surfaces of the magnetic bodies 2A, 2B, and 2C other than the side surfaces 2Ae, 2Be, and 2Ce and the side surfaces 2Af, 2Bf, and 2Cf. In this case, it is possible to suppress structural defects due to thermal expansion while securing adhesion of the magnetic bodies 2A, 2B, and 2C to the resin material 5.

The first length dimension of the magnetic bodies 2A, 2B, and 2C in the X-axis direction (first direction) extending along the side surfaces 2Ae, 2Be, and 2Ce may be smaller than the second length dimension of the magnetic bodies 2A, 2B, and 2C in the Y-axis direction (second direction) extending along the side surfaces 2Ae, 2Be, and 2Ce and orthogonal to the X-axis direction, and the gap 20 may have a larger separation distance at the center than the end portions of the side surfaces 2Ae, 2Be, and 2Ce of the magnetic bodies 2A, 2B, and 2C in the X-axis direction. In the side surfaces 2Ae, 2Be, and 2Ce of the magnetic bodies 2A, 2B, and 2C, the amount of displacement in the vicinity of the central position 26 in the X-axis direction is larger than that in the vicinity of the end portion 25 at the time of thermal expansion. Therefore, structural defects can be suppressed by setting the separation distance of the gap 20 to a size corresponding to the displacement due to the thermal expansion.

In the magnetic bodies 2A, 2B, and 2C, the first length dimension in the X-axis direction extending along the side surfaces 2Ae, 2Be, and 2Ce may be smaller than the second length dimension in the Y-axis direction extending along the side surfaces 2Ae, 2Be, and 2Ce and orthogonal to the X-axis direction, and the gap 20 may have a larger separation distance at the center than the end portions of the side surfaces 2Ae, 2Be, and 2Ce of the magnetic bodies 2A, 2B, and 2C in the Y-axis direction. In the side surfaces 2Ae, 2Be, and 2Ce of the magnetic bodies 2A, 2B, and 2C, the amount of displacement in the vicinity of the central position 28 in the Y-axis direction is larger than that in the vicinity of the end portion 27 at the time of thermal expansion. Therefore, structural defects can be suppressed by setting the separation distance of the gap 20 to a size corresponding to the displacement due to the thermal expansion.

The resin material 5 may be in contact with the magnetic bodies 2A, 2B, and 2C at portions of the side surfaces 2Ae, 2Be, and 2Ce of the magnetic bodies 2A, 2B, and 2C near the end portion 25. In this case, the adhesion between the magnetic bodies 2A, 2B, and 2C and the resin material 5 can be enhanced in a portion where the displacement due to thermal expansion is small.

The inductor 1 may further include a plurality of magnetic powders 40, and the plurality of magnetic powders 40 may include the first magnetic powder 41 present in the resin material 5 and the second magnetic powder 42 present in the gap 20. In this case, it is possible to suppress structural defects due to thermal expansion while securing magnetic characteristics of the inductor 1.

The DC-DC converter 500 may include the inductor 1 described above.

According to the DC-DC converter 500, it is possible to obtain functions and effects similar to those of the inductor 1 described above.

The present disclosure is not limited to the above-described embodiments.

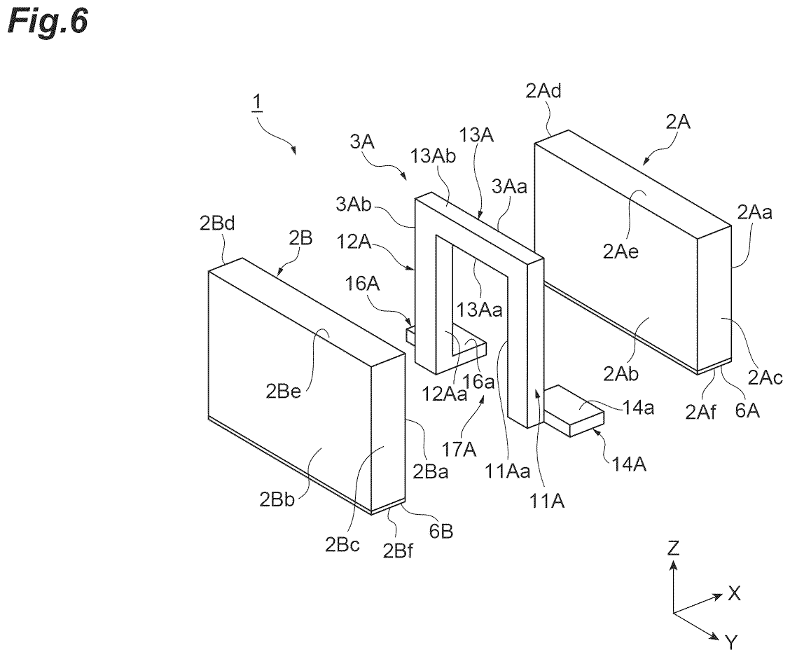

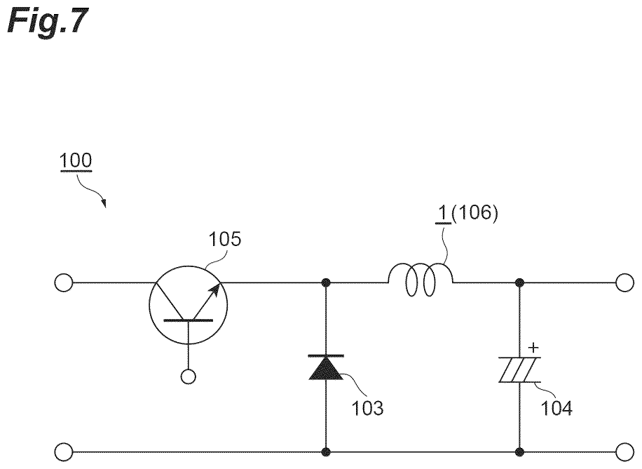

In the above-described embodiment, the inductor includes a plurality of coil conductors, but the number of coil conductors is not particularly limited, and the inductor may include one coil conductor. For example, the inductor 1 illustrated in FIG. 6 includes one coil conductor 3A and magnetic bodies 2A and 2B. Such one coil conductor 3A may be adopted in the DC-DC converter 100 illustrated in FIG. 7. As illustrated in FIG. 7, the DC-DC converter 100 includes a pair of input terminals to which a DC input voltage is input, a pair of output terminals, a switching element 105 and a choke coil 106 connected in series to the high potential side of the pair of input terminals, a diode 103 connected between a connection point between the switching element 105 and the choke coil 106 and a low potential side of the pair of input terminals, and a capacitor 104 connected between the pair of output terminals. The DC-DC converter 100 operates as a step-down converter that steps down an input DC voltage by switching on and off the switching element 105 on the basis of a control signal from a control circuit (not illustrated).

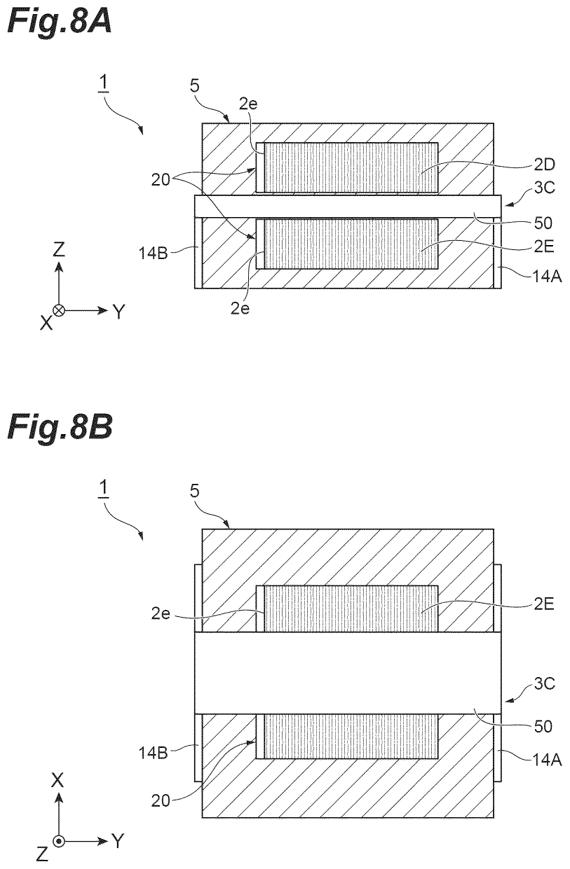

Structures of the coil conductor and the magnetic body are not limited to those adopted in the above-described embodiments, and may be changed as appropriate without departing from the concept of the present disclosure. For example, structures illustrated in FIGS. 8A to 10D may be adopted. In each of FIGS. 8A to 10D, the resin material 5 is partially cut, and the coil conductor and the magnetic body inside are illustrated.

For example, an inductor 1 as illustrated in FIGS. 8A and 8B may be adopted. The inductor 1 illustrated in FIGS. 8A and 8B includes a coil conductor 3C and a pair of magnetic bodies 2D and 2E. In FIG. 8B, a gap 20 between the resin material 5 and a side surface 2e of the magnetic body 2E is indicated by a solid line by cutting the resin material 5 in the Z-axis direction at a position of the magnetic body 2E on the negative side in the Z-axis direction. In FIG. 8B, a shape of the conductor portion 50 is indicated by a solid line by omitting the magnetic body 2D on the positive side in the Z-axis direction. The coil conductor 3C includes terminal portions 14A and 14B formed on surfaces of the resin material 5 opposed to each other in the Y-axis direction, and a conductor portion 50 extending in the Y-axis direction between the terminal portions 14A and 14B. The magnetic body 2D is disposed on the positive side in the X-axis direction with respect to the conductor portion 50, and the magnetic body 2E is disposed on the negative side in the X-axis direction. A stacking direction of the magnetic bodies 2D and 2E is set to the Y-axis direction. The inductor 1 has the gap 20 between the resin material 5 10 and the side surface 2e on one side (the negative side in the Y-axis direction) in the stacking direction.

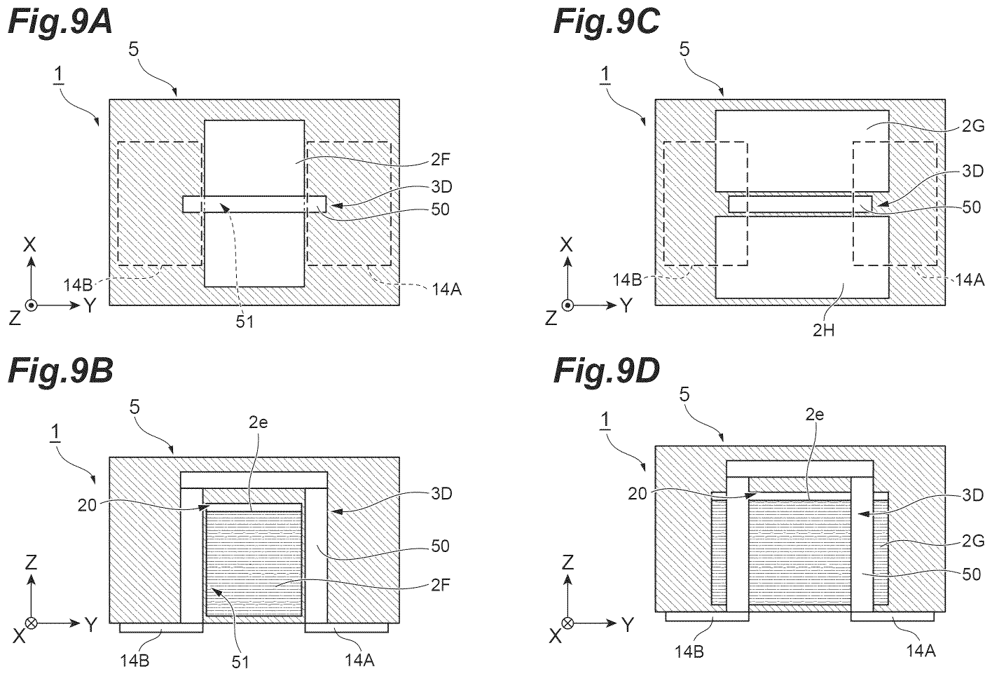

For example, an inductor 1 as illustrated in FIGS. 9A and 9B may be adopted. The inductor 1 illustrated in FIGS. 9A and 9B includes a coil conductor 3D and a magnetic body 2F. The coil conductor 3D includes terminal portions 14A and 14B formed on the negative surface of the resin material 5 in the Z-axis direction, and a gate-shaped conductor portion 50. The conductor portion 50 has a portion extending from the terminal portions 14A and 14B to the positive side in the Z-axis direction and a portion connecting upper ends of the extending portions. The 20 conductor portion 50 has a penetrating portion 51 penetrating in the X-axis direction. The magnetic body 2F is provided to penetrate the penetrating portion 51 in the X-axis direction. A stacking direction of the magnetic body 2F is set to the Z-axis direction. The inductor 1 has a gap 20 between the resin material 5 and a side surface 2e on one side (the positive side in the Z-axis direction) in the stacking direction.

For example, an inductor 1 as illustrated in FIGS. 9C and 9D may be adopted. The inductor 1 illustrated in FIGS. 9C and 9D includes a coil conductor 3D and a pair of magnetic bodies 2G and 2H. The pair of magnetic bodies 2G and 2H is provided to sandwich a penetrating portion 51 in the X-axis direction. A stacking direction of the magnetic bodies 2G and 2H is set to the Z-axis direction. The inductor 1 has a gap 20 between the resin material 5 and a side surface 2e on one side (the positive side in the Z-axis direction) in the stacking direction.

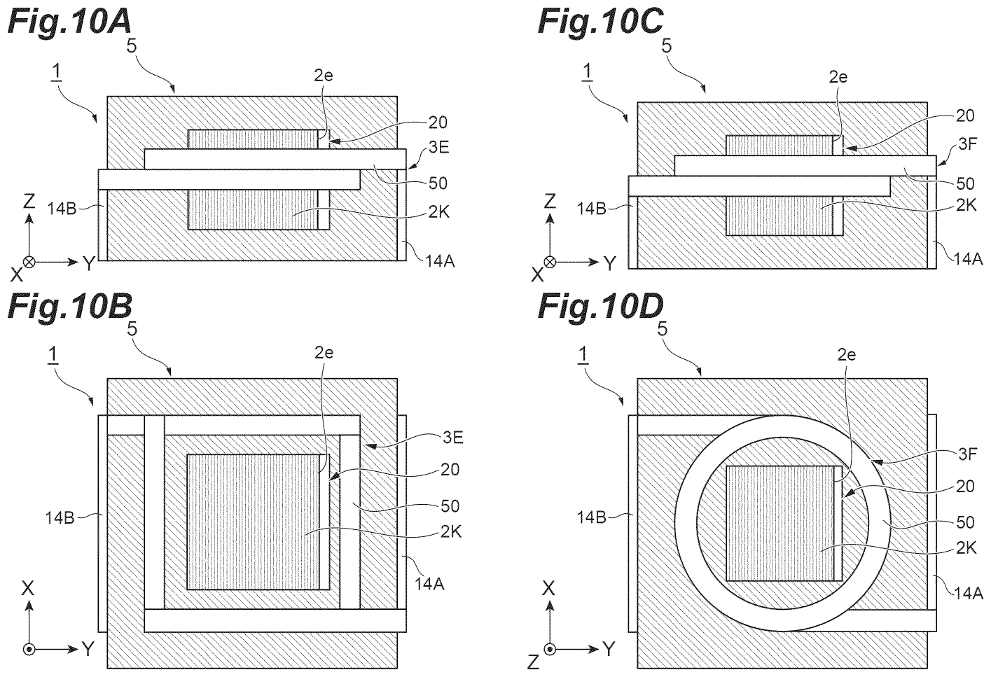

For example, an inductor 1 as illustrated in FIGS. 10A and 10B may be adopted. The inductor 1 illustrated in FIGS. 10A and 10B includes a coil conductor 3E and a magnetic body 2K. The coil conductor 3E includes terminal portions 14A and 14B formed on surfaces of the resin material 5 opposed to each other in the Y-axis direction, and a conductor portion 50 wound in a rectangular annular shape. The conductor portion 50 is wound such that a winding axis extends in the Z-axis direction. The magnetic body 2K is disposed inside the conductor portion 50. A stacking direction of the magnetic body 2K is set to the Y-axis direction. The inductor 1 has a gap 20 between the resin material 5 and a side surface 2e on one side (the positive side in the Y-axis direction) in the stacking direction. A shape of the conductor portion 50 is not particularly limited, and as illustrated in FIGS. 10C and 10D, a coil conductor 3F having an annular conductor portion 50 may be adopted.

### Aspect 1

An inductor including:
a coil conductor;
a magnetic body; and
a resin material including the coil conductor and the magnetic body therein, in which
a gap is provided between the resin material and at least one first surface of the magnetic body.

### Aspect 2

The inductor according to Aspect 1, in which
the magnetic body has a stacked structure of a magnetic ribbon and an adhesive resin, and
the first surface of the magnetic body is an outermost surface in a stacking direction in the stacked structure.

### Aspect 3

The inductor according to Aspect 2, further including
a resin member, in which
the magnetic body has a second surface that is an outermost surface on an opposite side to the first surface in the stacking direction, and
the resin member is disposed at a position facing the second surface.

### Aspect 4

The inductor according to Aspect 2 or 3, in which
the magnetic body has a second surface disposed on a side opposite to the first surface in the stacking direction, and
the resin material is in close contact with a surface other than the first surface and the second surface of the magnetic body.

### Aspect 5

The inductor according to any one of Aspects 1 to 4, in which
a first length dimension of the magnetic body in a first direction extending along the first surface is smaller than a second length dimension of the magnetic body in a second direction extending along the first surface and orthogonal to the first direction, and
the gap has a larger separation distance at a center than an end portion of the first surface of the magnetic body in the first direction.

### Aspect 6

The inductor according to any one of Aspects 1 to 5, in which
a first length dimension of the magnetic body in a first direction extending along the first surface is smaller than a second length dimension of the magnetic body in a second direction extending along the first surface and orthogonal to the first direction, and
the gap has a larger separation distance at a center than an end portion of the first surface of the magnetic body in the second direction.

### Aspect 7

The inductor according to Aspect 5, in which the resin material is in contact with the magnetic body in a portion of the first surface of the magnetic body near an end portion.

### Aspect 8

The inductor according to any one of Aspects 1 to 7, further including
a plurality of magnetic powders, in which
the plurality of magnetic powders include a first magnetic powder present in the resin material and a second magnetic powder present in the gap.

### Aspect 9

A DC-DC converter including the inductor of any one of Aspects 1 to 8.

### REFERENCE SIGNS LIST

1 Inductor
2A, 2B, 2C, 2D, 2E, 2F, 2G, 2H, 2K Magnetic body
3A, 3B, 3C, 3D, 3F Coil conductor
5 Resin material
6A, 6B, 6C Resin member
20 Gap
30 Magnetic ribbon
10 31 Adhesive resin
40 Magnetic powder
41 First magnetic powder
42 Second magnetic powder
100, 500 DC-DC converter

What is claimed is:

1. An inductor comprising:
a coil conductor;
a magnetic body; and
a resin material including the coil conductor and the magnetic body therein, wherein
a gap is provided between the resin material and at least one first surface of the magnetic body.

2. The inductor according to claim 1, wherein
the magnetic body has a stacked structure of a magnetic ribbon and an adhesive resin, and
the first surface of the magnetic body is an outermost surface in a stacking direction in the stacked structure.

3. The inductor according to claim 2, further comprising
a resin member, wherein
the magnetic body has a second surface that is an outermost surface on an opposite side to the first surface in the stacking direction, and
the resin member is disposed at a position facing the second surface.

4. The inductor according to claim 2, wherein
the magnetic body has a second surface that is an outermost surface on an opposite side to the first surface in the stacking direction, and
the resin material is in close contact with a surface other than the first surface and the second surface of the magnetic body.

5. The inductor according to claim 1, wherein
a first length dimension of the magnetic body in a first direction extending along the first surface is smaller than a second length dimension of the magnetic body in a second direction extending along the first surface and orthogonal to the first direction, and
the gap has a larger separation distance at a center than an end portion of the first surface of the magnetic body in the first direction.

6. The inductor according to claim 1, wherein
a first length dimension of the magnetic body in a first direction extending along the first surface is smaller than a second length dimension of the magnetic body in a second direction extending along the first surface and orthogonal to the first direction, and
the gap has a larger separation distance at a center than an end portion of the first surface of the magnetic body in the second direction.

7. The inductor according to claim 5, wherein the resin material is in contact with the magnetic body in a portion of the first surface of the magnetic body near an end portion.

8. The inductor according to claim 1, further comprising
a plurality of magnetic powders, wherein
the plurality of magnetic powders include a first magnetic powder present in the resin material and a second magnetic powder present in the gap.

9. A DC-DC converter comprising the inductor according to claim 1.
